(19) United States
(12) Patent Application Publication
(10) Pub. No.: US 2018/0253322 A1
(43) Pub. Date: Sep. 6, 2018

(54) ELECTRONIC DEVICE AND MODE SWITCHING METHOD THEREOF

(71) Applicant: Lenovo (Beijing) Co., Ltd., Beijing (CN)

(72) Inventor: Chunlong YANG, Beijing (CN)

(21) Appl. No.: 15/911,755

(22) Filed: Mar. 5, 2018

(30) Foreign Application Priority Data
Mar. 3, 2017 (CN) 201710126842.5

(51) Int. Cl. G06F 9/445; G06F 1/16

(52) U.S. Cl. CPC G06F 9/44505; G06F 1/169; G06F 1/1632

(57) ABSTRACT

An electronic device and a mode switching method of the electronic device are provided. The method includes: detecting whether the electronic device is connected to a first device, and in response to the electronic device being connected to the first device, configuring the electronic device in a non-vibrational mode. The first device receives display data sent by the electronic device, the display data is displayed at a second device, and the second device is different from the electronic device.

### CROSS-REFERENCES TO RELATED APPLICATIONS

This application claims priority to Chinese Patent Application No. 201710126842.5, filed on Mar. 3, 2017, the entire contents of which are hereby incorporated by reference.

### TECHNICAL FIELD

The present disclosure generally relates to the field of electronic technology and, more particularly, relates to an electronic device and a method for switching the mode of electronic device.

### BACKGROUND

In recent years, as the industry of smart phones develops rapidly, the market share of the computers decreases year after year, and the usage frequency of the smart phones becomes far higher than the usage frequency of the computers. Current smart phones can be used as a host of the computer, thus turning out to become a mobile office equipment. However, certain deficiencies exist when this type of mobile office equipment is applied for office use. For example, the smart phone may be connected to a monitor via a smart dock. If the smart phone launches the vibrational mode, the vibration may impact the connection between the smart phone and the smart dock.

### BRIEF SUMMARY OF THE DISCLOSURE

One aspect of the present disclosure provides a method for switching mode of an electronic device. The method includes: detecting whether the electronic device is connected to a first device, and in response to the electronic device being connected to the first device, configuring the electronic device in a non-vibrational mode. The first device receives display data sent by the electronic device, the display data is displayed at a second device, and the second device is different from the electronic device.

Another aspect of the present disclosure provides an electronic device including a processor and a memory. The memory stores machine-readable instructions, and when being executed by the processor, the machine-readable instructions enable the processor to detect whether the electronic device is connected to a first device, and in response to the electronic device being connected to the first device, configure the electronic device in a non-vibrational mode. The first device receives display data sent by the electronic device, the display data is displayed at a second device, and the second device is different from the electronic device.

Another aspect of the present disclosure provides a computer-readable storage medium. The computer-readable storage medium stores computer-executable instructions for execution by a processor to: detect whether the electronic device is connected to a first device, and in response to the electronic device being connected to the first device, configure the electronic device in a non-vibrational mode. The first device receives display data sent by the electronic device, the display data is displayed at a second device, and the second device is different from the electronic device.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 illustrates a flow chart of an example of a method for switching mode of an electronic device in accordance with some embodiments of the present disclosure;

FIG. 2 illustrates a flow chart of another example of a method for switching mode of an electronic device in accordance with some embodiments of the present disclosure;

FIG. 3 illustrates an example of an application scenario of an electronic device in accordance with some embodiments of the present disclosure;

FIG. 4 illustrates a block diagram of an example of an electronic device in accordance with some embodiments of the present disclosure;

FIG. 5 illustrates a block diagram of an example of a mode switching system for an electronic device in accordance with some embodiments of the present disclosure;

FIG. 6 illustrates an example of an electronic device switching from a vibrational mode to a silent mode in accordance with some embodiments of the present disclosure; and

FIG. 7 illustrates another example of an electronic device switching from a silent mode to a vibrational mode in accordance with some embodiments of the present disclosure.

### DETAILED DESCRIPTION

Various aspects, advantages, and features of the present disclosure will become apparent to those skilled in the relevant art with reference to the accompanying drawings and detailed descriptions of embodiments disclosed hereinafter. In the present disclosure, technical terms “including” and “comprising” and their derivatives mean inclusion without limitation. Further, the term “or” is inclusive, meaning and/or.

In the specification, various embodiments applied to describe principles of the present disclosure are for illustrative purposes, and shall not be construed as limiting of the scope of the present disclosure. With reference to the accompanying drawings, the following descriptions are used to fully understand various embodiments defined by the claims and their equivalents of the present disclosure. Such descriptions include various specific details to aid understanding, and these details shall be considered as for illustrative purposes only.

Thus, those ordinarily skilled in the relevant art shall understand that, without departing from the scope and spirit of the present disclosure, various modifications and alterations may be made to the disclosed embodiments. Further, for clarification and conciseness, descriptions of well-known functions and structures are omitted. Throughout the accompanying drawings, the same or like reference numerals refer to the same or like structures, functions or operations.

In the accompanying drawings, some block diagrams and/or flow charts are illustrated. It should be understood that some blocks or combination thereof in the block diagrams and/or flow charts may be implemented by computer program instructions. These computer program instructions may be provided to processor(s) of general-purpose computers, specialized computers, or other programmable data processing devices, such that when being executed by the processor(s), such instructions may establish device(s) for realizing functions/operations illustrated in the block diagrams and/or flow charts.

The present disclosure provides a method for switching mode of an electronic device. The method includes: detecting whether the electronic device is connected to a first device, where the first device is configured to receive display data sent by the electronic device, and the display data is configured to be displayed at a second device. The second device may be different from the electronic device. The method further includes: when the electronic device is detected to be connected to the first device, configuring the electronic device in a non-vibrational mode. For example, the non-vibrational mode may be a silent mode or a beep mode, and when the electronic device is in the non-vibrational mode, the electronic device does not vibrate in response to an event, such as an incoming call or incoming message, which supposedly causes the electronic device to vibrate in the vibrational mode.

For example, in the beep mode, in response to an event supposedly causing the electronic device to vibrate in the vibrational mode, the electronic device beeps or plays a sound instead of vibrates. For example, in the silent mode, in response to an event supposedly causing the electronic device to vibrate in the vibrational mode, the electronic device may not vibrate or play any sound, thus leaving the user undisturbed. There are also other non-vibrational modes, and the present disclosure is not limited thereto.

FIG. 1 illustrates a flow chart of an example of a method for switching mode of an electronic device. As shown in FIG. 1, the method includes: detecting whether the electronic device is connected to a first device (S11). The first device is configured to receive display data sent by the electronic device. The display data may be displayed at the first device, or the display data may be transmitted by the first device to a second device for display at the second device. The second device may be different from the electronic device.

Further, the disclosed electronic device may be a cellphone, or a tablet such as a PAD, etc. The first device may be a smart dock or other dock stations, etc. The second device may be a monitor, a smart TV, or a monitor of a computer, etc.

For example, during detection of whether the electronic device is connected to the first device or not (S11), the electronic device may be found to be connected to the first device via a wired connection, or the electronic device may be found to be connected to the first device via a wireless connection. For example, the electronic device may be connected to the first device via a data cable, a physical interface of the first device, bluetooth, or WIFI. For example, the detection of connection may be performed by manually detecting the connection of the data cable, or using a sensor of the electronic device to detect the connection implemented through bluetooth or WIFI.

Further, using the first device to receive the display data sent by the electronic device and displaying the display data at the second device may be a part of S11, and the display data disclosed herein may be a display interface of the electronic device, such as a program interface running in the electronic device. Or, the display data may be a display interface generated by the electronic device for the second device, including a main screen and a program interface running in the electronic device, etc. Further, the display data may also be various types of reminders generated by the electronic device, such as call reminder, message reminder, Wechat reminder, or QQ reminder, where Wechat and QQ are messaging apps.

Further, the second device may be different from the electronic device. For example, the electronic device may be primarily configured to generate or store the display data, and the second device may be primarily configured to display the display data. Thus, the application fields of the electronic device and the second device are often different.

The aforementioned method may further include: when the electronic device is detected to be connected to the first device, configuring the electronic device to be in a non-vibrational mode (S12). FIG. 6 illustrates an example of an electronic device switching from a vibrational mode to a silent mode. As shown in FIG. 6, in one example, when the electronic device, e.g., a mobile phone, is detected to be connected to the first device, the electronic device may be configured to switch from a vibrational mode to a silent mode, or any other non-vibrational mode.

After detection, a detection result is generated and may be further displayed, for example, at the second device. The detection result may include whether a connection condition between the electronic device and the first device is satisfying or not. If the detection result shows that the connection between the electronic device and the first device is satisfying, for example, when sending and receiving of the signal between the electronic device and the first device is stable, the electronic device may be configured to be in a non-vibrational mode.

Alternatively, if the detection result shows that the connection between the electronic device and the first device is not satisfying, for example, when the signal between the electronic device and the first device is not stable, reminder information may be provided to remind the user that the electronic device is not well connected to the first device.

Further, when the electronic device is configured to be in the non-vibrational mode in S12, the non-vibrational mode may specifically refer to a silent mode. In the silent mode, the electronic device does not send out a warning tone nor generate vibration. The user may also configure the non-vibrational mode to other modes based on preferences, such as a beep mode. In the beep mode, the electronic device may send out a warning tone but generate no vibration. Further, in the non-vibrational mode, the notification of vibration may be prohibited.

By configuring the mode of the electronic device to be the silent mode, the user experience may be improved. For example, if instead of a non-vibrational mode such as the silent mode, the electronic device of the user is configured in a vibrational mode and the electronic device is connected to the first device via a data cable or a physical interface, when the electronic device vibrates, the stability of connection between the electronic device and the second device may be affected and the display data displayed at the second device may be lost.

Optionally, the electronic device used by the user may be connected to the first device in other connection ways. For example, a metallic touch point on the back cover of the electronic device may be connected correspondingly to a metallic touch point of the first device to realize transmission of the display data. Under such situation, if the electronic device of the user is configured in the vibrational mode, the vibration of the electronic device may seriously affect the transmission stability of the display data.

But, when the electronic device of the user is configured to be in the silent mode, the above-described issues may be avoided. For example, during practical operation, the user attention is often focused on the second device (e.g., a monitor) that displays the display data sent by the electronic device. When the electronic device is in the silent mode, if the electronic device has any notification information, the notification information may be displayed at the second device on which the user attention is focused. Thus, not only the disturbance to the stability of transmission of the display data caused by vibration of the electronic device in the vibrational mode may be avoided, but also the notification information received by the electronic device may catch attention from the user that watches a display screen of the second device, which enables the user to timely process important events.

In some embodiments, when the electronic device is detected to be connected to the first device, the electronic device may be automatically switched to the non-vibrational mode. The non-vibrational mode may enable the connection portion between the electronic device and the first device to be in a stable status. For example, when the user is in a meeting and the mobile phone (e.g., as the electronic device) of the user is connected to a smart dock (e.g., as the first device), the mobile phone may be automatically switched to a silent mode (non-vibrational mode). Under such situation, if the mobile phone of the user receives a phone call, the connection between the mobile phone and the smart dock is not affected, and the data displayed at the second device may not affected.

In some embodiments, the first device and the second device may be the same device. For example, the first device and the second device may be integrated into one device, or the first device and the second device may be two individual devices between which data connection is realized. For example, the first device and the second device may be both computers, or the first device and the second device may be an integrated all-in-one computer. Or, the first device may be a smart docket, and the second device may be a monitor.

Further, the user may select the types of the first device and the second device based on the working environment. Different combinations of the devices may be applied to different application scenarios.

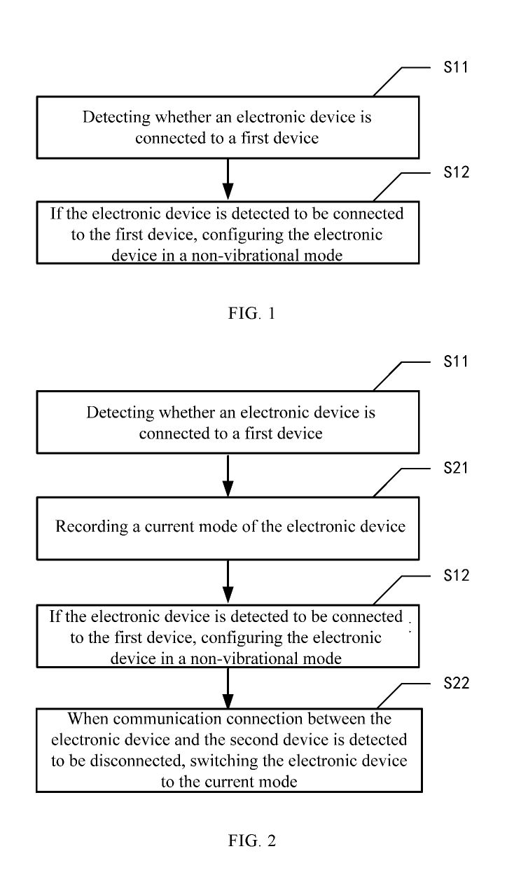

FIG. 2 illustrates a flow chart of another example of a method for switching mode of an electronic device. As shown in FIG. 2, the method include: detecting whether an electronic device is connected to a first device (S11), and when the electronic device is detected to be connected to the first device, configuring the electronic device to be in a non-vibrational mode (S12). Specific illustrations of S11 and S12 are provided in the aforementioned descriptions, and are not repeated herein.

Before configuring the electronic device to be in the non-vibrational mode, the method may additionally include: recording a current mode of the electronic device (S21). Optionally, the order between S11 and S21 is not limited, and may be altered based on actual needs. The current mode herein may refer to the mode of the electronic device before the electronic device is detected to be connected to the first device.

Referring to FIG. 2, the method may further include: when communication connection between the electronic device and the second device is disconnected, configuring the electronic device to be back in the current mode (S22). FIG. 7 illustrates an example of an electronic device switching from a silent mode to a vibrational mode. As shown in FIG. 7, in one example, when the electronic device is disconnected from the second device, a mobile phone (or any electronic device) may be configured to switch from a silent mode (i.e., non-vibrational mode) to a vibrational mode.

In some embodiments, the current mode of an electronic device may be a vibrational mode, and when the electronic device is detected to be connected to a smart dock (e.g., as the first device), the current mode of the electronic device may be switched to a non-vibrational mode (e.g., the silent mode). The smart dock may be connected a monitor (e.g., as the second device) to display data received from the electronic device (e.g., a display interface of the electronic device or a file) at the monitor. Further, when the electronic device is disconnected from the second device, for example, the electronic device disconnects with the second device by disconnecting with the first device, and electronic device may be switched from the non-vibrational mode back to the vibrational mode.

In some embodiments, the current mode of an electronic device may already be a non-vibrational mode, such as a silent mode. Under such situation, the non-vibrational mode of the electronic device may be recorded as the current mode, and in response to the electronic device being connected to a first device, an option may be provided to the user for selecting whether to maintain the electronic device in the current mode or switch the current mode of the electronic device to another non-vibrational mode. For example, when the current mode of the electronic device is the silent mode, the silent mode may be recorded; and in response to the electronic device being detected to be connected to the first device, the user may decide not to change the current mode of the electronic device, i.e., maintain the silent mode of the electronic device. Further, when communication connection between the electronic device and the second device is detected to be disconnected, the user may also have an option whether or not to switch the silent mode to other modes, such as a beep mode or a vibrational mode.

As such, the present disclosure provides a mode switching method of electronic device. When the electronic device is detected to be connected to the first device, the current mode of the electronic device is recorded, and after the current mode of the electronic device is recorded, the electronic device may be configured to be in a non-vibrational mode. When the communication connection between the electronic device and the second device is disconnected, the electronic device is recovered to be in the current mode.

In some embodiments, in S21, the current mode of the electronic device is recorded and the current mode of the electronic device recorded in S21 may be, for example, a beep mode or a silent mode. Further, in S22, the electronic device is recovered to the current mode, and the current mode that the electronic device is recovered to in S22 may be the mode recorded in S21.

Further, execution of S22 may bring convenience to the user. For example, when a meeting that the user attends is coming to an end, the user often pulls the mobile phone out from the smart dock into his or her pocket. The user often forgets to adjust the mode of the mobile phone back to the original mode (the current mode), which results in the fact that the user misses important messages such as phone calls and short messages.

For example, when original mode (current mode) of the mobile phone is the vibrational mode, when the mobile phone is connected to a smart dock, the mode of the mobile phone may be switched from the vibrational mode to a non-vibrational mode, such as a silent mode. By changing the mode of the mobile phone from the silent mode back to the vibrational mode when the user disconnects the mobile phone from the smart dock and puts the mobile phone in a pocket, the vibration of the mobile phone in response to receiving of a phone call or a message or other information may remind the user to check the mobile phone so as to avoid missing important messages. By executing S22, the mobile phone is changed back to the original mode (the current mode) when the user pulls out the mobile phone from the smart dock, such that important messages may be noticed by the user in a timely manner.

Further, regarding the communication connection between the electronic device and the second device being disconnected in S22, the disconnection between the electronic device and the second device may include two situations. The two situations may specifically refer to the electronic device being disconnected from the first device and the second device being in a not-in-use status.

The situation in which the electronic device is disconnected from the first device may be a situation in which, for example, the user pulls out the electronic device from a socket of the first device or cuts off the physical connection between the electronic device and the first device; however, the present disclosure is not limited thereto. The situation in which the second device is in the not-in-use status may specifically refer to the second device being powered off or the second device entering a sleep status, and the present disclosure is not limited thereto.

Optionally, the method may further include displaying notification of an event received by the electronic device at the second device. The event may for example refer to an important phone call, text message, or reminder, etc. That is, different from common existing technologies in which the electronic device vibrates to notify the user about existence of an event when receiving the event, the disclosed method may display notification of such event at the second device through a plurality of display forms. For example, the notification of the event may be displayed at the second device in a pop-up window or a bullet screen, and the present disclosure is not limited thereto. The pop-up window may be displayed for a pre-configured period of time, such as 2 seconds. The bullet screen may refer to a real-time comment or message that flies across the display screen of the second device like bullets.

For example, in existing technologies, the user is often notified of a message or an incoming call by vibration of the electronic device. Different from the existing technologies, in the present disclosure, because the electronic device is configured from the vibrational mode to the non-vibrational mode when the electronic device is connected to the first device, the user may find notification of the message or incoming call through a pop-up window or bullet screen at a second device (e.g., a monitor) connected to the first device.

For example, when the user is at a meeting and suddenly the mobile phone of the user receives a phone call, a pop-up window may appear on the second device displaying the phone number of the caller or the phone number and the name of the corresponding caller, or a bullet screen carrying the name of the caller may be displayed on the second device to notify the user that there is an incoming call. Accordingly, the user may timely discover any phone call to avoid missing any important phone call.

The aforementioned method may avoid issues in existing technologies and provide convenience to the user. For example, the user may no longer worry about missing any phone call, or may no longer feel annoyed at the disconnection between the mobile phone and the smart dock due to the vibration of the mobile phone when receiving a call during work.

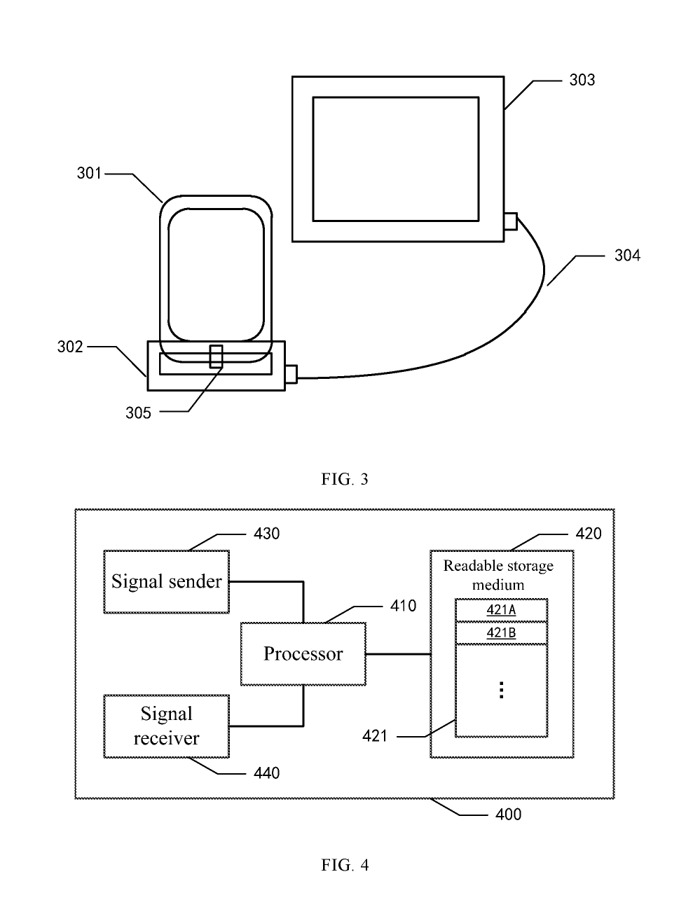

FIG. 3 illustrates an example of an application scenario of an electronic device in accordance with some embodiments of the present disclosure. As shown in FIG. 3, in a conference room of a company, a monitor 303 (second device) may be configured to display a series of media materials, such as PPT documents. The monitor 303 may be connected to a smart dock 302 (first device) via a data cable 304, and the smart dock 302 may include a physical interface 305 for connection to an electronic device 301. The electronic device 301 may be, for example, a cellphone. When the company prepares to hold a meeting at the conference room, a user that wants to display a particular PPT document on the monitor 303 may plug in his or her mobile phone (e.g., as electronic device 301) that stores the PPT document to the physical interface 305 of the smart docket 302 for connection to the monitor 303.

In existing technologies, when the user has an important phone call to answer during the meeting, the user has to set the mobile phone (e.g., electronic device 301) in a vibrational mode to avoid missing the call. However, when the mobile phone vibrates in response to the incoming important call, the PPT displayed on the monitor 303 may become blur or the window for displaying the PPT may turn black due to instable data transmission cause by the vibration. By the use of the disclosed electronic device and method, the blurred display of the PPT or the window for displaying the PPT turning to be black on the monitor 303 (second device) due to the vibration of the mobile phone 301 (electronic device) may be avoided, which improves user experience.

Further, the present disclosure provides an electronic device, and the electronic device may include a processor and a memory. The memory stores machine-readable instructions, and when being executed by the processor, the instructions may enable the processor to detect whether the electronic device is connected to a first device. The first device is configured to receive display data sent by the electronic device. The display data is configured to be displayed at a second device. The second device may be different from the electronic device.

Further, the disclosed electronic device may be a cellphone, or a tablet such as a PAD, etc. The first device may be a smart dock or other dock stations, etc. The second device may be a monitor, or a smart TV, or a monitor of a computer, etc.

Further, when detecting whether the electronic device is connected to the first device or not, the electronic device may be found to be connected to the first device via a wired connection, or the electronic device may be found to be connected to the first device via a wireless connection. For example, the electronic device may be connected to the first device via a data cable, a physical interface of the first device, bluetooth, or WIFI. Optionally, the detection of connection may be performed by manually detecting the connection of the data cable, or using a sensor of the electronic device to detect the connection via bluetooth or WIFI.

Further, when using the first device to receive the display data sent by the electronic device and displaying the display data in the second device, the display data may be a display interface of the electronic device, such as a program interface running in the electronic device. Or, the display data may be a display interface generated by the electronic device for the second device, including a main screen and a program interface running in the electronic device.

Further, the display data may also be various reminders generated by the electronic device, such as call reminder, message reminder, Wechat reminder, or QQ reminder, where Wechat and QQ are messaging apps.

Further, the second device may be different from the electronic device. For example, the electronic device is often configured to generate the display data, and the second device is configured to display the display data. The application fields of the electronic device and the second device are often different.

Further, if the processor detects that the electronic device is connected to the first device, the processor may set the electronic device in the non-vibrational mode. For example, referring back to FIG. 6, the processor may switch a mobile phone (electronic device) from a vibrational mode to a silent mode.

After detection, a detection result may be generated and viewed by the user. The detection result may include whether a connection condition between the electronic device and the first device is satisfying or not. If the detection result generated by the processor shows that the connection between the electronic device and the first device is satisfying, for example, the detection result shows that sending and receiving of the signals between the electronic device and the first device is stable, the processor may set the electronic device to be in a non-vibrational mode.

If the detection result generated by the processor shows that the connection between the electronic device and the first device is not satisfying, for example, when a signal between the electronic device and the first device is not stable, the processor may provide reminder information to remind the user that the electronic device is not well connected to the first device.

Further, when the electronic device is configured to be in the non-vibrational mode, the non-vibrational mode may be a silent mode. The user may also configure the non-vibrational mode to be other modes based on preferences. By configuring the mode of the electronic device to be a silent mode, the user experience may be improved. For example, if instead of a non-vibrational mode such as the silent mode, the electronic device of the user is configured in a vibrational mode and the electronic device is connected to the first device via a data cable or a physical interface, when the electronic device vibrates, the stability between the electronic device and the second device may be affected and the display data displayed at the second device may be lost.

Or, the electronic device used by the user may be connected to the first device in other connection ways. For example, a metallic touch point on a back cover of the electronic device may be connected correspondingly to a metallic touch point of the first device to realize transmission of display data. Under such situation, if the electronic device of the user is configured in the vibrational mode, the vibration of the electronic device may seriously affect the transmission stability of the display data.

When the electronic device of the user is configured to be in the silent mode; however, the above-described influence may be avoided. Further, in practical operation, the user attention is often focused on the monitor, and when the electronic device receives the notification information, the notification information may be displayed on the monitor that often has a larger display screen than the electronic device (e.g., the mobile phone), such that the notification information may not be missed by the user, thereby allowing the user to timely process important events.

In some embodiments, when the electronic device is detected to be connected to the first device, the electronic device may be automatically switched to the non-vibrational mode. The non-vibrational mode may enable the connection portion between the electronic device and the first device to be in a stable status. For example, when the user is in a meeting and the mobile phone of the user is connected to a smart dock, the mobile phone is automatically switched to a silent mode (non-vibrational mode). Under such situation, if the mobile phone of the user receives a phone call, the connection between the mobile phone and the smart dock is not affected, and the data displayed at the second device may not affected.

In some embodiments, the first device and the second device may be the same device. The first device and the second device may be integrated into one device, or the first device and the second device may be two individual devices between which data connection is realized. For example, the first device and the second device may be both computers, or the first device and the second device may be an integrated all-in-one computer. Optionally, the first device may be a smart docket, and the second device may be a monitor.

Further, the user may select the types of the first device and the second device based on the working environment. Different combinations of the devices may be applied to different application scenarios.

Further, the user may select the types of the first device and the second device based on the working environment. Different combinations of the devices may be applied to different application scenarios.

Further, before configuring the electronic device to be in the non-vibrational mode, the processor may record the current mode of the electronic device. Further, when the processor detects that the communication connection between the electronic device and the second device is disconnected, the processor may switch the electronic device back to the current mode.

As such, the present disclosure provides an electronic device, and when the processor detects that the electronic device is connected to the first device, the current mode of the electronic device may be recorded. After the current mode of the electronic device is recorded, the processor may execute to set the electronic device in the non-vibrational mode. When the processor detects that the communication connection between the electronic device and the second device is disconnected, the processor may recover the current mode of the electronic device. That is, the processor may set the electronic device back to the current mode, i.e., the mode of the electronic device before the electronic device is switched to the non-vibrational mode.

Regarding the current mode of the electronic device, the current mode may be a beep mode or a silent mode. Further, when the processor executes to recover the electronic device back to the current mode, the current mode herein may refer to the recorded mode as described previously.

The configuration of recording the current mode and recovering the current mode before the connection towards the second device is connected may bring about convenience to the user. For example, when a meeting that the user attends is coming to an end, the user often pulls the mobile phone out from the smart dock into his or her pocket. The user often forgets to adjust the mode of the mobile phone back to the original mode (the current mode), which results in the fact that the user misses important messages such as phone calls and short messages. The configuration of recording the current mode and recovering the current mode before the connection towards the second device is connected, however, enables the mobile phone to be recovered to the original mode (current mode) when the user pulls out the mobile phone from the smart dock.

Further, the discontinuation of the communication connection between the electronic device and the second device may include two situations. The two situations may specifically refer to the electronic device being disconnected from the first device, and the second device being in a not-in-use status.

The situation in which the electronic device is disconnected from the first device may be a situation in which, for example, the user pulls out the electronic device from a socket of the first device or cuts off the physical connection between the electronic device and the first device; however, the present disclosure is not limited thereto. The situation in which the second device is in the not-in-use status may specifically refer to the second device being powered off or the second device entering a sleep status, and the present disclosure is not limited thereto.

Further, the processor may display notification of an event for which the electronic device used to generate vibration on the second device. Further, for the display of the notification of the event for which the electronic device used to generate vibration on the second device, a plurality of display forms may be employed, such as a pop-up window or bullet screen. The present disclosure is not limited thereto.

For example, in existing technologies, the user is often notified of a message or call by vibration of the electronic device. Different from the existing technologies, according to the present disclosure, the notification is often displayed in the form of pop-up window or bullet screen on the second device. For example, when the user is at a meeting and suddenly the mobile phone of the user receives a phone call, a pop-up window may appear on the second device displaying the phone number of a caller, or the name (carried by a bullet screen) of the caller may be displayed on the second device to notify the user that there is an incoming call. Accordingly, the user may timely discover any phone call, thereby avoiding to miss any important phone calls.

The aforementioned method and electronic device may solve at least partial issues in existing technologies and provide convenience to the user to certain extent. For example, the user may no longer worry about missing any phone call, or feel annoyed at the disconnection between the mobile phone and the smart dock due to the vibration of the mobile phone when receiving a call during work.

FIG. 4 illustrates a block diagram of an example of an electronic device. As shown in FIG. 4, the electronic device 400 may include a processor 410, a computer-readable storage medium 420, a signal sender 430, and a signal receiver 440. The electronic device 400 may execute the methods described with reference to FIG. 1 and FIG. 2, such that when the electronic device is connected to the first device, the electronic device may be automatically configured in a non-vibrational mode.

For example, the processor 410 may, for example, include a general-purpose microprocessor, an instruction set processor, and/or related chip set, and/or specialized microprocessor (e.g., Application Specific Integrated Circuit, ASIC), etc. The processor 410 may further include an onboard memory configured for buffering purposes. The processor 410 may be a single processing unit or a plurality of processing units executing different actions or steps included in the method disclosed in the flow charts.

The computer readable storage medium 420 may, for example, include any medium that is able to include, store, deliver, broadcast, or transmit an instruction. For example, the readable storage medium may include but not limited to an electric, magnetic, optical, electromagnetic, infrared or semiconductor system, device, unit or medium. The readable storage media may, for example, specifically be a magnetic storage medium such as a magnetic tape or hard drive disk (HDD), an optical storage medium such as a CD-ROM, a memory such as a random-access memory (RAM) or a flash memory, and/or a wired or wireless communication link.

The computer readable storage medium 420 may include a computer program 421, and the computer program 421 may include codes/computer executable instructions. When being executed by the processor 410, the computer program may enable the processor 410 to execute methods described with reference to FIG. 1 and FIG. 2, or any variation thereof.

The computer program 421 may be configured to comprise computer program codes that include a computer program modules. For example, in some embodiments, the codes in the computer program 421 may include one or more program modules, such as a module 421A and a module 421B, etc. It should be noted that the division methods of the modules and the number of the modules are not fixed, and those skilled in the relevant art may apply appropriate program modules or combinations thereof based on actual situations. When such program modules are executed by the processor 410, the processor 410 may implement the methods described with reference to FIG. 1 and FIG. 2, or any variation thereof.

Further, the processor 410 may use the signal sender 430 and the signal sender 440 to execute the methods described with reference to FIG. 1 and FIG. 2 or any variation thereof.

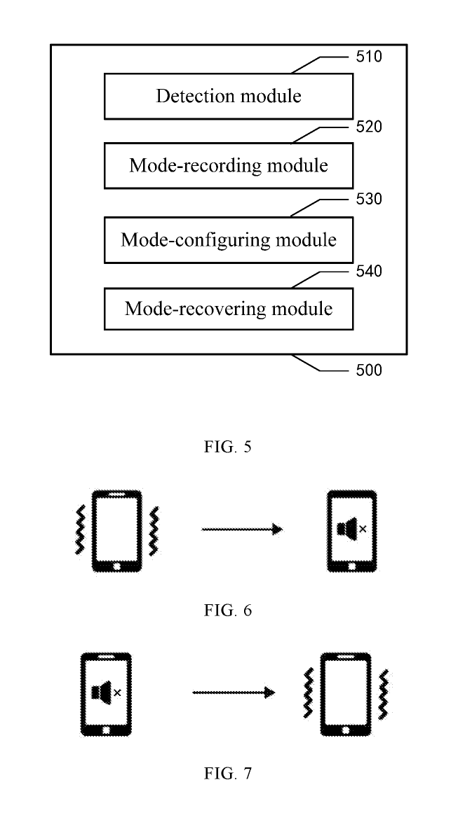

FIG. 5 illustrates a block diagram of an example of a mode switching system for an electronic device. As shown in FIG. 5, the mode switching system 500 may include a detection module 510, a mode-recording module 520, a mode-configuring module 530, and a mode-recovering module 540. The mode switching system 500 of the electronic device may execute the methods described with reference to FIG. 1 and FIG. 2, such that when the electronic device is connected to the first device, the electronic device is automatically configured in the non-vibrational mode.

For example, the detection module 510 is configured to detect whether the electronic device is connected to the first device. The first device is configured to receive display data sent by the electronic device, and the display data is configured to be displayed at a second device. The second device may be different from the electronic device.

The mode-recording module 520 is configured to record a current mode of the electronic device before the electronic device is configured in the non-vibrational mode. The mode-configuring module 530 is configured to, if the electronic device is detected to be connected to the first device, configuring the electronic device in the non-vibrational mode. The mode-recovering module 540 is configured to, when the communication connection between the electronic device and the second device is disconnected, recover the electronic device to be in the current mode.

Further, the sending and receiving of the signal in the electronic device may refer to descriptions with reference to FIG. 1 and FIG. 2, which are not repeated herein.

The aforementioned illustrations of the disclosed embodiments teach those skilled in the relevant art to implement or employ the present disclosure. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for switching mode of an electronic device, comprising:
detecting whether the electronic device is connected to a first device, wherein
the first device receives display data sent by the electronic device,
the display data is displayed at a second device, and
the second device is different from the electronic device; and
in response to the electronic device being connected to the first device, configuring the electronic device in a non-vibrational mode.

2. The method according to claim 1, wherein:
the first device and the second device are a same device; or
the first device and the second device are integrated into a device; or
the first device and the second device are two individual devices, wherein data connection is able to be established between the first device and the second device.

3. The method according to claim 1, further comprising:
before configuring the electronic device to be in the non-vibrational mode, recording a current mode of the electronic device;
detecting a communication connection between the electronic device and the second device; and
in response to a disconnection of the communication connection between the electronic device and the second device, recovering the electronic device to be in the current mode.

4. The method according to claim 3, wherein:
the disconnection of the communication connection between the electronic device and the second device includes:
a disconnection between the electronic device and the first device, or
the second device being in a not-in-use status.

5. The method according to claim 1, further comprising:
for an event supposedly causing the electronic device to vibrate, displaying a notification of the event on the second device as the electronic device is configured in the non-vibrational mode.

6. The method according to claim 5, wherein:
the notification of the event is displayed on the second device through a pop-up window or a bullet screen.

7. The method according to claim 1, wherein:
the first device is a smart dock for sending display data received from the electronic device to the second device, and
the second device includes a display screen for displaying the display data.

8. An electronic device, comprising:
a processor; and
a memory, wherein the memory stores machine-readable instructions, and when being executed by the processor, the machine-readable instructions enable the processor to:
detect whether the electronic device is connected to a first device, wherein the first device receives display data sent by the electronic device, the display data is to be displayed at a second device, and the second device is different from the first device, and
in response to the electronic device being connected to the first device, configuring the electronic device in a non-vibrational mode.

9. The electronic device according to claim 8, wherein:
the first device and the second device are a same device; or
the first device and the second device are integrated into a device; or
the first device and the second device are two individual devices, wherein data connection is able to be established between the first device and the second device.

10. The electronic device according to claim 8, wherein the processor is further executed to:
before configuring the electronic device to be in the non-vibrational mode, record a current mode of the electronic device;
detecting a communication connection between the electronic device and the second device; and
in response to a disconnection of the communication connection between the electronic device and the second device being disconnected, recover the electronic device to be in the current mode.

11. The electronic device according to claim 10, wherein:
the disconnection of the communication connection between the electronic device and the second device includes:
a disconnection between the electronic device and the first device, or
the second device being in a not-in-use status.

12. The electronic device according to claim 8, wherein the processor is further configured to:
for an event supposedly causing the electronic device to vibrate, display notification of the event on the second device as the electronic device is configured in the non-vibrational mode.

13. The electronic device according to claim 12, wherein:
the notification of the event is displayed on the second device through a pop-up window or a bullet screen.

14. The electronic device according to claim 8, wherein:
the first device is a smart dock for sending display data received from the electronic device to the second device, and
the second device includes a display screen for displaying the display data.

15. A computer-readable storage medium, the computer-readable storage medium storing computer-executable instructions for execution by a processor to:
detect whether the electronic device is connected to a first device, wherein the first device receives display data sent by the electronic device, the display data is to be displayed at a second device, and the second device is different from the first device, and
in response to the electronic device being connected to the first device, configuring the electronic device in a non-vibrational mode.

16. The computer-readable storage medium according to claim 15, wherein:
the first device and the second device are a same device; or
the first device and the second device are integrated into a device; or
the first device and the second device are two individual devices, wherein data connection is able to be established between the first device and the second device.

17. The computer-readable storage medium according to claim 15, further comprising:
before configuring the electronic device to be in the non-vibrational mode, recording a current mode of the electronic device;
detecting a communication connection between the electronic device and the second device; and
in response to a disconnection of the communication connection between the electronic device and the second device, recovering the electronic device to be in the current mode.

18. The computer-readable storage medium according to claim 17, wherein:
the disconnection of the communication connection between the electronic device and the second device includes:
a disconnection between the electronic device and the first device, or
the second device being in a not-in-use status.

19. The computer-readable storage medium according to claim 15, further comprising:
for an event supposedly causing the electronic device to vibrate, displaying a notification of the event on the second device as the electronic device is configured in the non-vibrational mode.

20. The method according to claim 19, wherein:
the notification of the event is displayed on the second device through a pop-up window or a bullet screen.
